(19) United States
(12) Patent Application Publication
(10) Pub. No.: US 2010/0057902 A1
(43) Pub. Date: Mar. 4, 2010

(54) Scal-free management networks

(75) Inventor: Scott Alan Isaacson, Kamuela, HI (US)

Correspondence Address: KING & SCHICKLI, PLLC, 247 NORTH BROADWAY, LEXINGTON, KY, 40507, US

(73) Assignee: Novell, Inc.

(21) Appl. No.: 12/229,998

(22) Filed: Aug. 28, 2008

(51) Int. Cl. G06F 15/173

(52) U.S. Cl. 709/224; 709/223

(57) ABSTRACT

Methods and apparatus involve production servers in a data center of an enterprise and management servers arranged in a scale-free manner to monitor, for instance, the health and general service status and availability of the production servers. Representatively, the production servers are first identified and then the management servers are analyzed to see if they can be deployed in a scale-free arrangement therewith. If so, the scale-free arrangement satisfies the proportionality equation P(k)˜k^{-γ} where γ is 1, 2 or 3. If not, the management servers are reserved until such time as they are able to fit in a scale-free manner. Computer program products are also utilized to assist in such calculations. Deployment of the production servers in a scale-free configuration is still another feature as is contemplating the physical limitations of servers (e.g., capacity, memory, number of connections, etc.) since each does not individually scale infinitely.

### FIELD OF THE INVENTION

Generally, the present invention relates to computing devices and their arrangement in computing environments. Particularly, although not exclusively, it relates to management servers in a data center, for example, arranged in a scale-free manner to monitor the health and general service status and availability of the production servers of the data center. Other features include server arrangements, power law distributions, and computer program products, to name a few.

### BACKGROUND OF THE INVENTION

As presently exists, networked computing devices have a diversity of configurations in which they can be deployed relative to one another, such as random, hierarchical, linear, scale-free, etc. In Linked (Barabási, Albert-László Linked: How Everything is Connected to Everything Else, 2004 ISBN 0-452-28439-2), for example, Barabasi describes the history of networks, how nodes are inter-connected, and what its relationship means for the network. He examines not just computer networks, but all types of networks from human social networks, to biological systems within a single organism, to languages, to transportation systems, to the spread of disease, etc. In his conclusions, a random network finds any node just as likely to be connected to another node as any other node in the network. Hierarchical networks, which almost never naturally occur, are constructed for specific purposes by humans (e.g., traditional enterprise or military organizational structure). Linear networks join one node to the next node and are susceptible to failures since there are only single paths from any one node to any other node. In contrast, scale-free networks tend to be the most pervasive of all network structures since they occur in almost all natural and biological systems.

In more detail, scale-free networks also are found with a small number of nodes acting as “highly connected hubs” (high degree), although most nodes are of low degree. Further, the structure and dynamics of scale-free networks are independent of a system's size N, and its number of nodes. In other words, a network that is scale-free has nodes with the same properties no matter its ultimate number of its nodes. Their defining characteristic is that their degree distribution follows a power law distribution, whereby the x-axis is the “number of nodes in the network,” the y-axis is the “number of connections per node,” and the curve roughly follows P(k)˜k^{-γ}. In turn, most nodes of the power law relationship fit such that there are a very small number of connections (back to hubs), while only a small number of nodes (hubs) have many connections. In fact, the relationship veers so steeply upward towards the origin, that a few nodes (like google.com for the Web) become super hubs, basically the starting point for entire networks. In comparison to earlier days, however, Barabasi found the Web architecture to be hierarchical or randomly arranged, but with the advent of search engines (such as the Google or Yahoo search engines), the Web has become largely scale-free. That is, a Web-user does not start at a random page on the Internet and follow random or serial links until they get to the web site of their choosing. Instead, they start at a hub, like google.com, and, upon clicking a provided web link, proceed directly to their chosen web page.

Taking another example, the modern day air transportation system is one that shows a scale-free configuration. Namely, to get from any one airport to any other airport, there are usually two or fewer hops. In the first, the flight passenger flies from an originating airport to a hub airport and, from there, they fly one more hop from the hub airport to the destination airport. Alternatively, they fly direct from the originating airport to their destination. In contrast, a bus transportation system is linear or hierarchical whereby a passenger gets on at a first stop, and travels many stops to their destination, including sometimes the transfer of buses where they also get on at a first stop and travel past many intermediary stops. While the early days of aviation may have also been linear or hierarchical, as with the Web, such is not the case today and are now clearly scale-free.

Returning to the computing system context, modern data centers of an enterprise have both production servers, e.g., servers to undertake enterprise activities such as email, computing applications, etc., and management servers to monitor the production servers for health and general service status and availability. While many data centers have self-organized their configuration of production servers into scale-free networks, there is still no clear topology that best fits the management and monitoring network that surrounds the production network. To date, in fact, the state of the art is such that system administrators arbitrarily select groups of production servers to monitor (random) and then they install management servers for those management servers (hierarchical). Consequently, there is no clear management topology, which leads to costly overhead in the form of poorly positioned management servers, too many management servers, underutilized management servers, etc. Also, as the numbers of production servers grow or shrink in the ever-evolving networks of modern-day data centers, poor initial planning results in later haphazardly-configured architectures.

Accordingly, a need exists in the art of monitoring and managing production servers for better configurations leading to less costly overhead. The need further extends to systems that can resolve growth and shrinking patterns as networks evolve over time. Naturally, any improvements along such lines should further contemplate good engineering practices, such as ease of implementation, unobtrusiveness, stability, etc.

### SUMMARY OF THE INVENTION

The foregoing and other problems become solved by applying the principles and teachings associated with the hereinafter-described scale-free management networks. At a high level, methods and apparatus involve production servers in a data center of an enterprise and management servers arranged in a scale-free manner to monitor, for instance, the health and general service status and availability of the production servers.

In a representative embodiment, the production servers of the data center are all identified and then the types and numbers of management servers are analyzed to see if they can be deployed in a scale-free arrangement therewith. If so, the scale-free arrangement satisfies a power law distribution in the form of the proportionality equation P(k)˜k^{-γ} where γ is 1, 2 or 3. If not, on the other hand, the management servers are kept in reserve until such time as they are able to fit in a scale-free manner. Deployment of the production servers in a scale-free configuration is still another consideration as is contemplating the physical limitations of servers (e.g., capacity, memory, number of connections, etc.) since each does not individually scale infinitely.

Computer program products are also utilized to assist in various calculations, and may be stand alone products with executable instructions available as a download or on a computer readable medium. They may also be available for installation on a network appliance or individual computing devices.

In any embodiment, certain realized advantages include (but are not limited to): application of the benefits of scale-free networks to the management network that monitors and controls the production network (which is often, itself a scale-free network); and algorithmic techniques for satisfying scale-free configurations with nodes that are management servers and edges that are connections to production servers and other management servers.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention for scale-free management networks in a data center;

FIG. 2 is a flow chart in accordance with the present invention for deploying management servers in a scale-free manner;

FIG. 3 is a power law graph in accordance with the present invention for deploying management servers in a scale-free manner;

FIG. 4 is a flow chart in accordance with the present invention for deploying management servers in a scale-free manner upon the evolution of the network; and

FIGS. 5A, 5B, 5C and 5D are diagrammatic views in accordance with the present invention illustrating a representative deployment of a scale-free management network.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for scale-free management networks are hereinafter described.

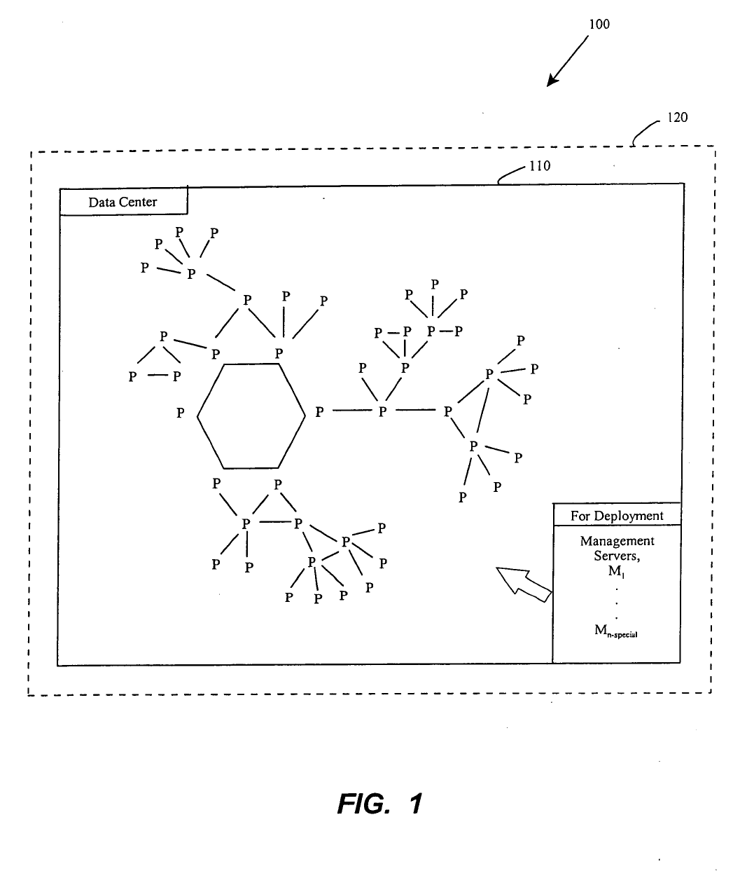

With reference to FIG. 1, a representative computing environment 100 includes a data center 110 of an enterprise 120. It includes, among other things, pluralities of production servers P connected together to form a network. It can encompass both physical and virtual production servers and such may be co-located in a single room of an enterprise or spread over many physical locations, such as different states or continents, but is shown together in the figure for convenience. Also, as is often the case, the production servers fill a variety of roles for the enterprise and include, but are not limited to, email servers, application servers, print servers, proxy servers, game servers, communication servers, etc. However, to manage the production servers, such as for determining the health and general service status and availability of the production servers, the environment further includes a plurality of management servers M (from M₁ through M_{N-Special}) available for deployment. To avoid the randomness or hierarchical nature of deployment in the prior art, the management servers M are deployed in the environment in a scale-free manner. Also, as the network evolves, as the production servers P grow or shrink in the environment to accommodate various concerns of the enterprise, for example, the management servers are flexibly deployed to maintain its scale-free configuration.

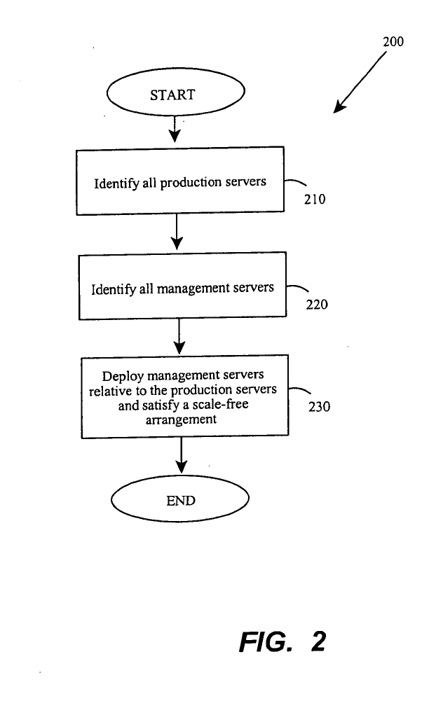

With reference to FIG. 2, a high-level organization of the scale-free deployment process 200 includes first identifying all the production servers 210, e.g., P₁ though P_{M}, and then identifying all the management servers 220. At step 230, the deployment then consists of deploying only those management servers M relative to the production servers P that will satisfy a scale-free arrangement. In other words, if deployment of the management servers will result in other than a scale-free configuration, deployment does not occur. Alternatively, deployment occurs only to the extent that it can be done in a scale-free manner, with other management servers left un-deployed until such time as they can be properly deployed in the scale-free environment.

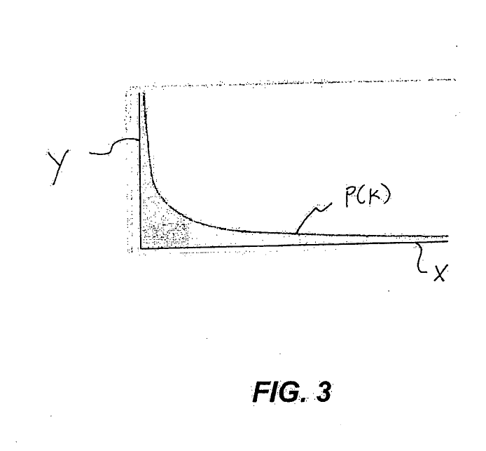

In one instance, this means deployment of the management servers satisfies the power law distribution, P(k)˜k^{-γ}, (FIG. 3) whereby the probability P(k) that a node in the network connects with k other nodes is roughly proportional to k^{-γ}, and γ is 1, 2 or 3 (described further below). It also provides that some nodes will act as highly connected hubs, while most nodes are of low connectivity, including the x-axis being the “number of nodes in the network” and the y-axis being the “number of connections per node.” In turn, the management servers M will be deployed independently of the network's size N, such that no matter the number of nodes or hubs, the management servers will have the same probability P(k). As a result, the recited problems of overhead with random or hierarchical networks are overcome.

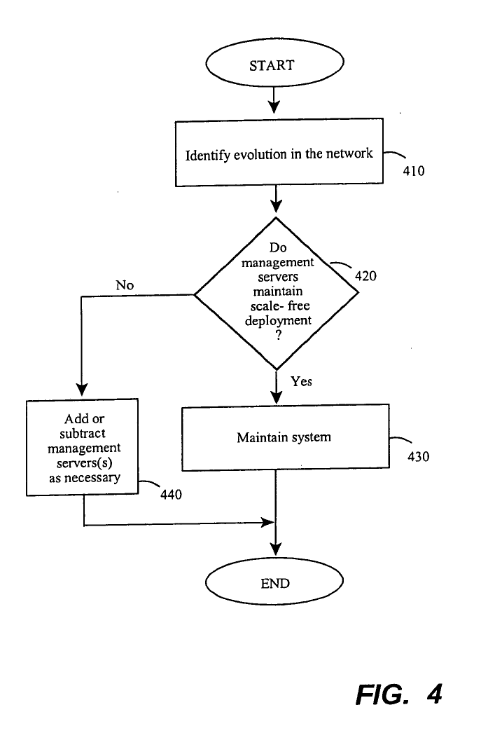

Appreciating that, over time, the computing system environment of FIG. 1 evolves in size (as new production servers become available for use or as functionality becomes obsolete and servers are eliminated or reduced in functionality and combined with other servers, etc.), it is necessary to identify the evolution of the network, step 410, FIG. 4, so as to determine whether nodes are needed to be added or removed in the environment to maintain the scale-free architecture of the deployed management server(s), step 420. In the event the scale-free deployment is kept intact, the network deployment of management servers remains as is, step 430. On the other hand, if the scale-free deployment is not maintained with the network's evolution, such as the management servers no longer meet the probability function P(k), then the management servers are redeployed (added or subtracted as necessary) so as to satisfy the scale-free distribution, step 440. In this manner, as enterprises grow or shrink to meet various workplace demands, the management of the production servers is scaled which maintains robustness and results in a data center that is efficient, resilient, etc. It also prevents the haphazardness that often occurs in the prior art when data centers are left to evolve in piecemeal fashion.

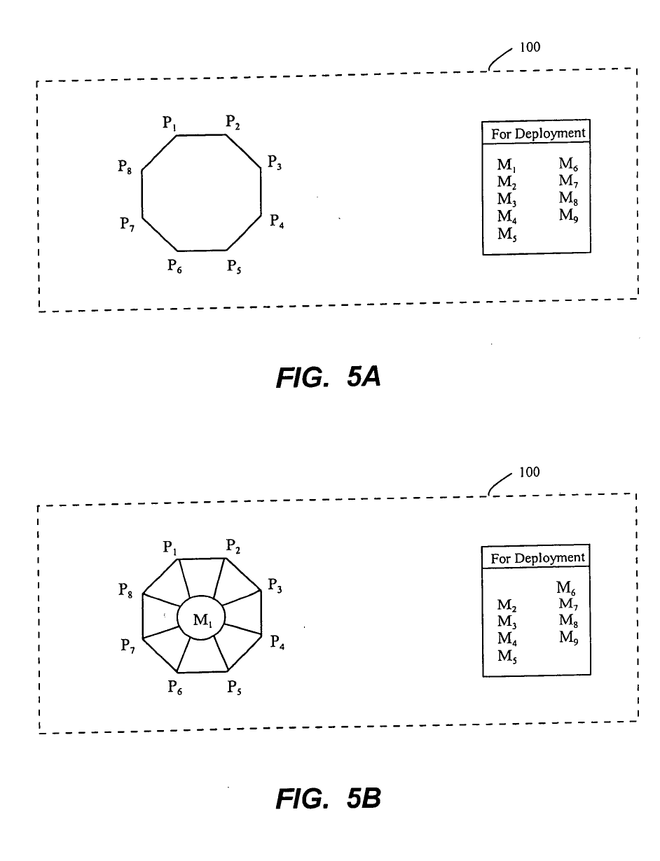

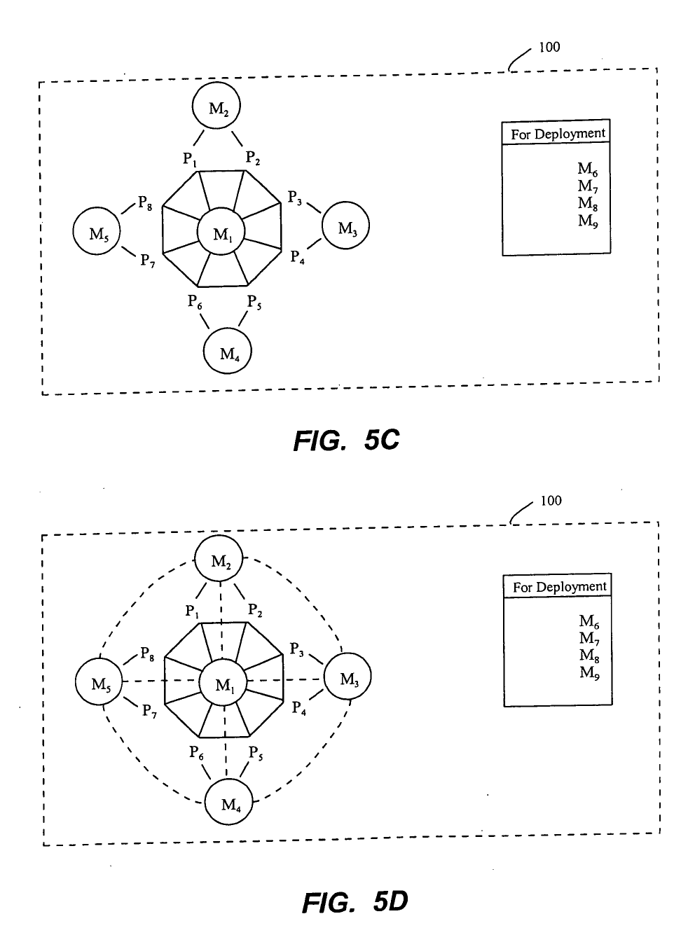

As a working Example, the following scale-free deployment is provided in combination with FIGS. 5A, 5B, 5C and 5D.

### EXAMPLE

1. Let every production server in the computing environment 100 be identified as P₁ through P_{M} for M production servers. (In FIGS. 5A, 5B, 5C and 5D, there are P₁ through P₈ production servers.)
2. Let every management server be identified, and those to be deployed are identified as M₁ through M_{N-Special} for order N management servers. (In FIGS. 5A, 5B, 5C and 5D, there are a total of M₁ through M₉ management servers, but not all will be deployed for their deployment would avoid satisfaction of a scale-free arrangement. As will be seen, only management servers M₁ through M₅ are deployed, thus _{N-Special}=5.)
3. To satisfy the power law P(k)˜k^{-γ}, whereby the probability P(k) that a node in the network connects with k other nodes and is roughly proportional to k^{-γ}, including the negative exponent γ ranging from 2 to 3 for real networks, and in some instances 1, the following table shows possible outcomes k⁻¹, k⁻² and k⁻³ for relatively small values of k, i.e., 1 through 8.

TABLE

| K | k⁻³ | k⁻² | k⁻¹ |
|---|---|---|---|
| 1 | 1.000 | 1.000 | 1.000 |
| 2 | 0.125 | 0.250 | 0.500 |
| 3 | 0.037 | 0.111 | 0.333 |
| 4 | 0.016 | 0.063 | 0.250 |
| 5 | 0.008 | 0.040 | 0.200 |
| 6 | 0.005 | 0.028 | 0.167 |
| 7 | 0.003 | 0.020 | 0.143 |
| 8 | 0.002 | 0.016 | 0.125 |

4. In turn, if a new node Mᵢ is deployed in the computing environment, it is only deployed on the condition that the power law is satisfied and it, Mᵢ, can be connected to the proper number of production servers P.
5. For instance, (and selecting γ=2, but could be any γ) under the k⁻² column, if N is 1 (the value k in the TABLE), then N-Special is 1, and one and only one server is deployed, e.g., M₁ through M_{N-Special}. If N is 2, then N-Special is 5 and (4+1) servers are needed. If N is 3, then N-Special is 11 and (10+1) servers are needed, and so on.

In more detail showing the calculations of this process, if N is 4, then N-Special is 17 or (16+1). That is, the TABLE shows a value of 0.063 for N=4. Inverted, 0.063 is 15.87. Since there is no realistic outcome of a 0.87^{th} of a server, a rounding function takes places to the next whole number of servers. Thus, for N=4, the number of servers necessary for deployment with the production servers is 16 servers plus the first server.
6. As in FIGS. 5A, 5B, 5C and 5D, eight production servers exist. Thus, there are 5 management servers needed for deployment to satisfy the scale-free power law distribution. Namely, M₁ in FIG. 5B is selected for deployment and is connected to all eight production servers. Thereafter, in FIG. 5C, management servers M₂, M₃, M₄, and M₅ are each connected to ¼th (0.250 in the TABLE under the k⁻² column) of the production servers (or eight divided by 4, which equals 2) so that all production servers become managed by an appropriate number of management servers. In FIG. 5D, these nodes or hubs are then connected to each other and to M₁ (dashed lines, FIG. 5D), thereby resulting in a scale-free outcome.

As should be noticed, however, the other management servers, e.g., M₆ through M₉, are not deployed since such would destroy the scale-free nature of the management servers relative to the eight production servers. It is not until there are further additions to the production servers P in the data center and two more (or eleven total) management servers for deployment, i.e., N=3, whereby N-Special=11, before M₆ through M₉ (along with new servers M₁₀ and M₁₁) will be selected for deployment.

Eventually, this growth pattern continues until M₁ has no more physical capacity (e.g., memory, number of connections, etc.) and a new M₁* is added as a peer to and connected with M₁ where M₁* starts the same pattern as M₁ all over again until its capacity is eventually reached. Ultimately, regardless of how many production servers exist, the resulting network of management servers is now a scale free management network that has the same scalability and resiliency attributes as the production network it is monitoring.

In any embodiment, the computing environment 100 contemplates computing devices in the form of production or management servers, but scale-free deployment can exist per other types of devices as well. Also, as the servers communicate with one another, they may also interface with other computing devices not shown. Further, connections may be of any type, such as wired, wireless or combinations thereof and may be direct or indirect. If direct, they typify connections within physical or network proximity (e.g., intranet). If indirect, they typify connections such as those found with the internet, satellites, radio transmissions, or the like. In this regard, other contemplated items include other servers, routers, peer devices, modems, Tx lines, satellites, microwave relays or the like. The connections may also form local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement, so long as the management servers are deployed to meet the scale-free limitation. (It is also desirable, but not required, that the production servers meet a scale-free deployment as well. It is likely that most data centers will have already evolved their production capacity in this fashion, and so additional redeployment of the production servers may not be required before application of the management network in a scale-free manner can occur.)

In any of the foregoing, skilled artisans will appreciate that enterprises can implement some or all of the embodiments with humans, such as system administrators, but may find it desirable to call on the calculating power of computing devices, executable code, or combinations thereof. In turn, methods and apparatus further contemplate computer executable instructions, e.g., code or software, as part of computer program products on readable media, e.g., disks for insertion in a drive of computing device, or available as downloads or direct use from an upstream computing device. When described in the context of such computer program products, it is denoted that components thereof, such as modules, routines, programs, objects, data structures, etc., perform particular tasks or implement particular abstract data types within various structures of the computing system which cause a certain function or group of function, and such are well known in the art.

Although the foregoing has been described in terms of specific embodiments, one of ordinary skill in the art will recognize that additional embodiments are possible without departing from the teachings of the present invention. This detailed description, therefore, and particularly the specific details of the exemplary embodiments disclosed, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of other figures.

1. In a computing system environment, a method of managing production servers of a data center, comprising:
identifying all the production servers;
identifying all available management servers for deploying with the production servers to monitor the health and general service status and availability of the identified production servers; and
deploying at least some of the identified management servers relative to the production servers and satisfy a scale-free arrangement.

2. The method of claim 1, further including determining whether deployment of additional management servers will violate the scale-free arrangement.

3. The method of claim 2, wherein if the deployment of additional management servers will violate the scale-free arrangement, further including avoiding deployment of the additional management servers.

4. The method of claim 2, wherein if the deployment of additional management servers will not violate the scale-free arrangement, further including deploying the additional management servers in a scale-free manner.

5. The method of claim 1, wherein the deploying the identified management servers relative to the production servers to satisfy the scale-free arrangement further includes substantially satisfying the proportionality equation P(k)˜k^{-γ}.

6. The method of claim 1, wherein upon one of the identified management servers reaching a physical capacity, deploying another management server as a peer to the one of the identified management servers.

7. The method of claim 6, wherein upon the another management server reaching a physical capacity, deploying still another management server as a peer to the another management server.

8. In a computing system environment, a method of managing production servers of a data center, comprising:
identifying all the production servers in the data center;
identifying all available management servers for deploying with the production servers to monitor the health and general service status and availability of the identified production servers;
determining whether the all available identified management servers can be deployed relative to the production servers in a scale-free manner; and
if not, deploying only those management servers of the all available identified management servers that will actually satisfy a scale-free arrangement.

9. The method of claim 8, wherein if the determining can satisfy the scale-free manner, further including deploying all management servers of the all available identified management servers.

10. The method of claim 8, further including deploying the all identified production servers in the data center in a manner that is scale-free, thereby having both the production servers and management servers in a scale-free configuration.

11. A data center, comprising:
a plurality of production servers for undertaking server functions of an enterprise; and
a plurality of management servers deployed with and connected to the production servers to monitor the health and general service status and availability of the production servers, wherein all the management servers are arranged in a scale-free manner about the production servers.

12. The data center of claim 11, wherein the production servers are also deployed in a scale-free configuration.

13. The data center of claim 11, further including one or more additional management servers available to the data center but that are not deployed in the data center because the one or more additional management servers cannot be deployed about the production servers in the scale-free manner.

14. The data center of claim 11, wherein one management server of the plurality of management servers is connected to every production server of the plurality of production servers.

15. The data center of claim 1 1, further including a computer program product available as a download or on a computer readable medium for loading on a computing device, the computer program product having executable instructions to calculate whether the management servers can be deployed relative to the production servers in the scale-free manner.

16. A data center, comprising:
a plurality of production servers for undertaking server functions of an enterprise;
a plurality of management servers deployed with and connected to the production servers to monitor the health and general service status and availability of the production servers, wherein all the deployed management servers are arranged in a scale-free manner about the production servers that are also arranged in a scale-free configuration; and
a computer program product available as a download or on a computer readable medium for loading on a computing device of the data center, the computer program product having executable instructions to calculate whether the management servers can be deployed relative to the production servers in the scale-free manner and, if so, to calculate how to connect the management servers.

17. The data center of claim 16, further including one or more additional management servers available to the data center but that are not deployed in the data center because the one or more additional management servers cannot be deployed about the production servers in the scale-free manner as determined by the computer program product.

18. The data center of claim 17, wherein the computer program product further includes executable instructions to calculate whether the production servers can be deployed in the scale-free configuration.

19. A computer program product available as a download or on a computer readable medium for loading on a computing device in a computing system environment to coordinate deployment of management servers relative to production servers of a data center, the computer program product comprising executable instructions to calculate whether the management servers can be deployed relative to the production servers in a scale-free manner.

20. The computer program product of claim 19, further including executable instructions to calculate whether the scale-free manner satisfies the proportionality equation P(k)˜k^{-γ} where γ is 1, 2 or 3.

21. The computer program product of claim 19, further including executable instructions to determine how many said management servers are needed to be deployed in the scale-free configuration according to how many said production servers exist in the data center.

22. The computer program product of claim 19, further including executable instructions to calculate how to connect the management servers to the production servers.

23. The computer program product of claim 19, further including executable instructions to calculate how to connect some of the management servers to other of the management servers.

24. The computer program product of claim 19, further including executable instructions to calculate capacity of the management servers.
